(19) United States
(12) Patent Application Publication
(10) Pub. No.: US 2021/0233395 A1
(43) Pub. Date: Jul. 29, 2021

(54) DIFFERENTIALLY PRIVATE SOLUTION FOR TRAFFIC MONITORING

(71) Applicants: LG Electronics Inc., Seoul (KR); UNICAMP, Sao Paulo (BR)

(72) Inventors: Rogerio V.M. Rocha, Sao Paulo (BR); Harsh Kupwade Patil, Fremont, CA (US)

(21) Appl. No.: 17/151,047

(22) Filed: Jan. 15, 2021

Related U.S. Application Data
(60) Provisional application No. 62/964,694, filed on Jan. 23, 2020.

(51) Int. Cl. G08G 1/052; G08G 1/01; G08G 1/127; G06F 17/18

(52) U.S. Cl. CPC G08G 1/052; G08G 1/0125; G06F 17/18; G08G 1/0141; G08G 1/127

(57) ABSTRACT

According to some embodiments, an instance-based data aggregation solution is disclosed herein for traffic monitoring based on differential privacy, focusing on event-level privacy. In some embodiments, an enhanced approach for differentially private solution (e.g., for average speed calculation) uses, employs, or is implemented with smooth sensitivity and a sample and aggregate framework.

### CROSS REFERENCE TO RELATED APPLICATIONS

The present application claims priority to U.S. Provisional Patent Application No. 62/964,694, “ENHANCED DIFFERENTIALLY PRIVATE SOLUTION FOR TRAFFIC MONITORING,” filed on 23 Jan. 2020, which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates to systems and methods for maintaining privacy, including a differentially private solution for traffic monitoring.

### BACKGROUND OF THE INVENTION

In recent years, privacy research has been gaining ground in vehicular communication technologies. Collecting data from connected vehicles presents a range of opportunities for government authorities and other entities to perform data analytics. Although many researchers have explored some privacy solutions for vehicular communications, the conditions to deploy the technology are still maturing, especially when it comes to privacy for sensitive data aggregation analysis.

### BRIEF DESCRIPTION OF THE DRAWINGS

FIG. 1 illustrates an environment in which systems and methods of the present disclosure can operate.

FIG. 2 is a block diagram of a computing device which can be used by any of the entities shown in FIG. 1, according to some embodiments.

FIGS. 3, 3A, and 3B illustrate communications among vehicles and other equipment in the example environment, according to some embodiments.

FIG. 4 illustrates a sample and aggregate framework, according to some embodiments.

FIG. 5 illustrates a method for calculating average speed in a differentially private way according to a basic approach, in some embodiments.

FIG. 6 illustrates a method for a Count function, according to some embodiments.

FIG. 7 illustrates a method for a Sum function, according to some embodiments.

FIG. 8 illustrates a method for calculating average speed in a differentially private way according to an enhanced approach, in some embodiments.

FIG. 9 illustrates a method for a Sample and Aggregate function, according to some embodiments.

FIG. 10 illustrates a method for a Smooth Median function, according to some embodiments.

FIG. 11 illustrates an example scenario for evaluating methods for calculating average speed in a differentially private way.

FIG. 12 is a table illustrating results of evaluation for the different methods in the example scenario of FIG. 11.

FIG. 13 illustrates an example scenario for evaluating methods for calculating average speed in a differentially private way.

FIG. 14 is a table illustrating results of evaluation for the different methods in the example scenario of FIG. 13.

FIG. 15 illustrates a method an Original Differential Privacy framework, according to some embodiments.

FIG. 16 illustrates a method a Sample and Aggregate function, according to some embodiments.

FIG. 17 illustrates a method for a modified Original Differential Privacy framework, according to some embodiments.

FIG. 18 illustrates a method for calculating average speed in a differentially private way according to a Hybrid approach, in some embodiments.

### DETAILED DESCRIPTION OF SOME EMBODIMENTS

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one skilled in the art. Like numbers in two or more figures represent the same or similar elements.

In this description, specific details are set forth describing some embodiments consistent with the present disclosure. Numerous specific details are set forth in order to provide a thorough understanding of the embodiments. It will be apparent to one skilled in the art, however, that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### Example Environment

In recent times, there has been a surge in digital technologies embedded in physical objects, leading to what is today known as the Internet of Things (IoT). This trend has also reached the automotive industry, which has shown a growing interest in exploring interaction models such as Vehicle-to-Vehicle (V2V), Vehicle-to-Infrastructure (V2I), and Vehicle-to-Pedestrian (V2P), collectively referred to as Vehicle-to-Everything (V2X) communications.

FIG. 1 illustrates a V2X environment in which systems and methods of the present disclosure can operate. V2X enables several applications aimed at improving transportation safety, efficiency, and human to machine interaction. For example, with V2X, vehicles can exchange or communicate information (e.g., for velocity, direction, and brake status) that can help drivers keep a safe distance from other vehicles while maintaining a suitable speed.

The V2X communications technology is a cornerstone for the development of Intelligent Transportation Systems (ITS). Mobility is a major concern in any city, and deploying ITS can make cities more efficient. ITS are an indispensable component of smart cities, achieving traffic efficiency while minimizing traffic problems. The adoption of ITS is widely accepted and it is used in many countries today. Because of its endless possibilities, ITS has become a multidisciplinary field of connective work and therefore many organizations around the world have developed solutions to provide ITS applications to meet demand.

Indeed, the U.S. Department of Transportation has initiated a “connected vehicles” program “to test and evaluate technology that will enable cars, buses, trucks, trains, roads and other infrastructure, and our smartphones or other devices to ‘talk’ to one another. Cars on the highway, for example, would use short-range radio signals to communicate with each other so every vehicle on the road would be aware of where other nearby vehicles are. Drivers would receive notifications and alerts of dangerous situations, such as someone about to run a red light as they [are] nearing an intersection or an oncoming car, out of sight beyond a curve, swerving into their lane to avoid an object on the road.” U.S. Department of Transportation at https://www.its.dot.gov/cv_basics/cv_basics_what.htm. “Connected vehicles could dramatically reduce the number of fatalities and serious injuries caused by accidents on our roads and highways. [They] also promise to increase transportation options and reduce travel times. Traffic managers will be able to control the flow of traffic more easily with the advanced communications data available and prevent or lessen developing congestion. This could have a significant impact on the environment by helping to cut fuel consumption and reduce emissions.” In some embodiments, the V2X environment for an ITS can comprise or be implemented with a Security Credential Management System (SCMS) infrastructure. The SCMS was developed in cooperation with the U.S. Department of Transportation and the automotive industry.

FIG. 1 shows a busy intersection with various entities or objects, such as vehicles 110V (cars, trucks, and possibly other types, e.g., trains or bicycles), pedestrians 110P, roadside equipment 110L (e.g., traffic lights, along with hub or gateway for short and longer-range communications). In a V2X environment for deploying ITS, each of the objects or entities 110 (110V, 110L, 110P, etc.)—each of which may be referred to as an “end entity” or “EE”—carries or incorporates equipment, such as smartphones, automotive information devices, or other computing devices. Using their respective computing devices, the objects or entities 110 communicate (e.g., wirelessly) to share information, coordinate, etc.

Each vehicle 110V may, for example, broadcast its location, speed, acceleration, route, direction, weather information, etc. Such broadcasts can be used to obtain advance information on traffic jams, accidents, slippery road conditions, and allow each vehicle to know where the other vehicles are, and so on. In response, vehicle recipients of such information may alert their drivers, to advise the drivers to stop, slow down, change routes, take a detour, and so on. The traffic lights can be automatically adjusted based on the traffic conditions broadcast by the vehicles and/or other objects 110.

With the emergence of the V2X communication and ITS technology, there is an inherent increase in vehicle safety, thus saving lives and fostering a safer driving experience. This technology allows vehicles to communicate with multiple devices on-the-go and when stationary, thereby introducing an entirely new set of communication infrastructure, applications, services, etc. Furthermore, it is perceived as one of the building blocks that can propel the quicker adoption of autonomous vehicles and smart cities.

Applications in ITS are broad, encompassing areas such as safety, cooperative driving, traffic optimization, among others. Although their use is not just limited to traffic congestion control and information, the introduction of information and communication technologies, especially in vehicles, is generally considered as means to achieve efficiency, safe and sustainable mobility. Specifically, collecting data from connected vehicles presents opportunities through aggregated data analysis for investigating driver behavior to vehicle manufacturers and insurers, monitoring traffic conditions to governmental agencies involved in tolling or traffic management, and to develop new services as needed.

While connected vehicles, V2X, and ITS technology offer the promise of increased safety, traffic flow, efficiency, etc., the large scale deployment of such technologies also requires addressing some challenges, especially security and privacy concerns. For example, in a V2X and ITS environment, information and data for connected vehicles will necessarily be generated and collected, leading to concerns about how such collected information can be used while preserving the privacy of individual vehicles and their drivers.

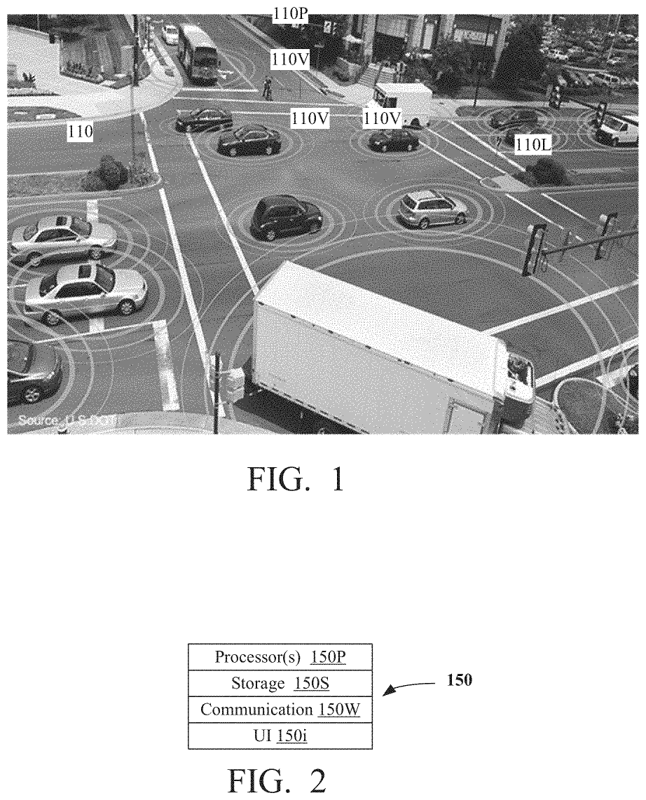

FIG. 2 illustrates an embodiment of a computing device 150 which is used by the vehicles or other entities and objects, e.g., for communicating, coordinating, etc. in the V2X environment of FIG. 1. As shown in FIG. 2, computing device 150 includes one or more computer processors 150P coupled to computer storage (memory) 150S, and wireless communication equipment 150W for radio communications.

Operation of computing device 150 is controlled by processor 150P, which may be implemented as one or more central processing units, multi-core processors, microprocessors, microcontrollers, digital signal processors, field-programmable gate arrays (FPGAs), application-specific integrated circuits (ASICs), graphics processing units (GPUs), tensor processing units (TPUs), and/or the like in computing device 150P.

Memory 150S may be used to store software executed by computing device 150 and/or one or more data structures used during the operation of computing device 150. Memory 150S may include one or more types of machine-readable media. Some common forms of machine-readable media may include a floppy disk, a flexible disk, hard disk, magnetic tape, any other magnetic medium, CD-ROM, any other optical medium, punch cards, paper tape, any other physical medium with patterns of holes, RAM, PROM, EPROM, EEPROM, FLASH-EPROM, any other memory chip or cartridge, and/or any other medium from which a processor or computer is adapted to read.

Processor 150P and/or memory 150S may be arranged in any suitable physical arrangement. In some embodiments, processor 150P and/or memory 150S may be implemented on the same board, in the same package (e.g., system-in-package), on the same chip (e.g., system-on-chip), and/or the like. In some embodiments, processor 150P and/or memory 150S may include distributed, virtualized, and/or containerized computing resources. Consistent with such embodiments, processor 150P and/or memory 150S may be located in one or more data centers and/or cloud computing facilities. In some examples, memory 150S may include non-transitory, tangible, machine-readable media that include executable code that when run by one or more processors (e.g., processor 150P) may cause the computing device 150, alone or in conjunction with other computing devices in the environment, to perform any of the methods described further herein

The computing device or equipment 150 may include user interface 150i, e.g., such as present in a smartphone, an automotive information device, or of some other type device, for use by pedestrians, vehicle drivers, passengers, traffic managers, and possibly other people.

Wireless communication equipment 150W of computing device 150 may comprise or be implemented with one or more radios, chips, antennas, etc. for allowing the device 150 to send and receive signals for conveying information or data to and from other devices. Under the control of processor 150P, wireless communication equipment 150W may provide or support communication over Bluetooth, Wi-Fi (e.g., IEEE 802.11p), and/or cellular networks with 3G, 4G, or 5G support.

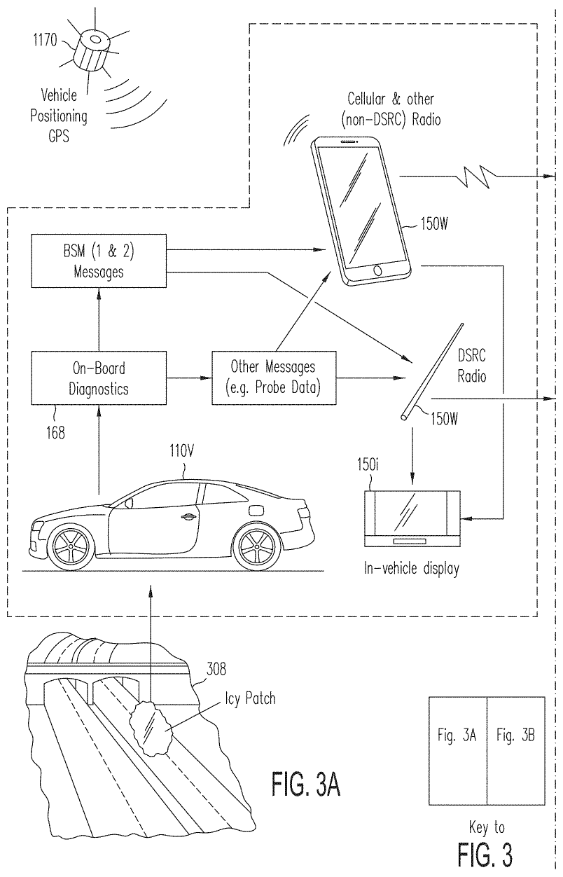

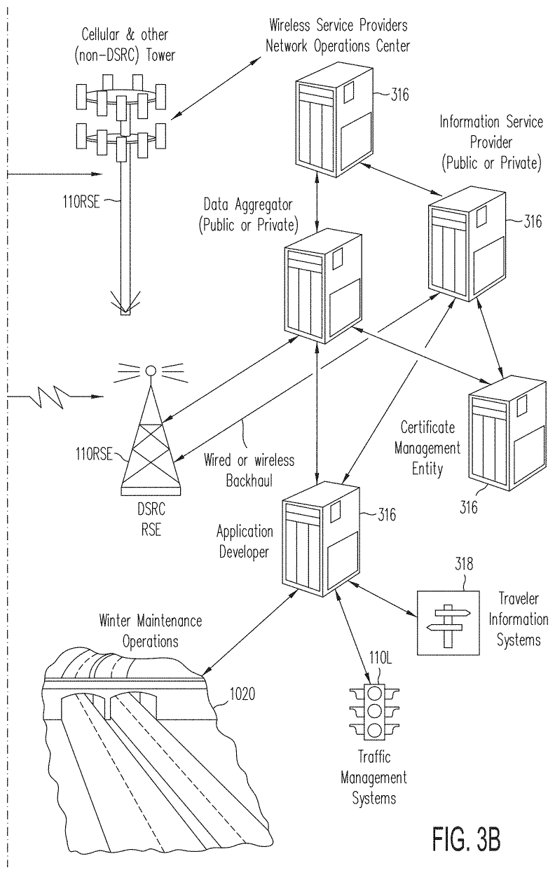

FIGS. 3, 3A, and 3B illustrate examples of communication schemes for entities or objects 110 or their computing devices and/or other equipment 150 (“object 110,” “user 110,” and “equipment 150” may be used interchangeably herein when no confusion arises), interacting via V2X or connected vehicle technology in an ITS. At scene 308, a vehicle 110V encounters an icy road patch.

The vehicle 110V includes on-board equipment (OBE) or on-board unit (OBU) 304 with one or more sensors—such as accelerometers, brake monitors, object detectors, LIDAR, etc.—for sensing conditions within and around vehicles 110V, such as sudden braking, wheel spin, potential collisions, etc. Using these sensors, the vehicle 110V may, for example, detect the icy road patch at scene 308. The sensors supply information to the OBE's computing device or equipment 150 (FIG. 2) so that it can take action accordingly, e.g., by automatically applying brakes, adjusting steering, and/or notifying the user via a display 150i in case the user needs to react. The computing device 150 may comprise an on-board diagnostics module 168 for performing diagnostics or analysis, for example, on the information provided by the sensors.

Different pieces of equipment on the vehicle 110V communicate by exchanging Basic Safety Messages (BSM) and/or other messages with each other and other vehicles. The BSM messages are described in detail in Whyte et al., “A security credential management system for V2V communications,” IEEE Vehicular Networking Conference, 2013, pp. 1-8, and CAMP, “Security credential management system proof-of-concept implementation—EE requirements and specifications supporting SCMS software release 1.1,” Vehicle Safety Communications Consortium, Tech. Rep., May 2016 (available: https:/www.its.dot.gov/pilots/pdf/SCMS_POC_EE_Requirements.pdf), both of which are incorporated by reference.

A vehicle or other object 110 can obtain its location, for example, by using GPS satellites 1170 or cellular triangulation. The vehicle 110V may also include communication equipment 150W, which, in some embodiments, can include a Direct Short Range Communications (DSRC) radio and non-DSRC radio equipment such as a mobile phone. The vehicle may thus communicate through a cellular system or other roadside equipment (RSE) 110RSE directly, i.e., without intermediate network switches. RSE may alternately be referred to as a roadside unit (RSU). In some embodiments, the RSE can be implemented with or in a base station (BS) proximate a road. An RSE may include some of the same or similar equipment as vehicle 110V, including computing devices 150, sensors, user interfaces, communication equipment, etc. The RSE may act as a gateway to other networks, e.g., the Internet. Using the communication equipment 150W, vehicle 110 can communicate BSM messages and other information to other vehicles, entities, or objects 110 in the V2X or connected vehicle environment. Thus, vehicle 110V/150 may inform the other parts of the environment or ITS of the icy patch at scene 308. Likewise, another vehicle 110 may be located in scene 1020 and may alert other vehicles of winter maintenance operations at that scene.

A traffic management system 110L may comprise equipment—e.g., stoplights, crosswalk lights, etc. located in or near roads, highways, crosswalks, etc.—to manage or control traffic of vehicles, persons, or other objects and entities. Traffic management system 110L may include some of the same or similar equipment as vehicle 110V, including computing devices 150, sensors, user interfaces, communication equipment, etc.

Computer systems 316 process, aggregate, generate or otherwise operate on information sent to or received from vehicles 110V, traffic management systems 110L, and other objects or entities 110 in the V2X or connected vehicle technology environment, along with their respective computing devices 150. Also shown is a traveler information system 318. Computer systems 316 can be implemented in or incorporate, for example, one or more servers. These computer systems 316, for example, provide or support location and map information, driving instructions, traffic alerts and warnings, information about roadside services (e.g., gas stations, restaurants, hotels, etc.). The computer systems 316 may receive information from the various vehicles, entities, and objects 110 in the environment, process and communicate information or instructions throughout the environment to manage the objects, e.g., by adjusting signaling on traffic lights, rerouting traffic, posting alerts or warnings, etc.

In some embodiments, one or more of the various objects, entities, equipment, computers, and infrastructure shown in FIGS. 3, 3A, and 3B can implement, communicate with, or support a Traffic Data Center (TDC). A TDC can be a component of an ITS, and comprises a technical system administered by a transportation authority. In some embodiments, much of the data in an ITS is collected and transmitted to a TDC, processed and analyzed for managing traffic in real-time or further operations. A vehicular urban sensor network is a network paradigm for sensing data collection in urban environments. The mobile networks formed mainly by vehicles 110V and fixed bases (e.g., base stations such as RSU or RSE) in a road infrastructure are known as Vehicular Ad Hoc Networks (VANETs). The RSE or RSU is equipment installed on the road that receives and sends messages to the TDC or vehicle equipped with an OBU, a wireless transmitter/receiver to communicate with other nodes. Each vehicle or base station acts as a node that receives and sends messages, or as a router that receives a packet and forwards it to the final recipient.

In some embodiments, the underlying technology used in VANETs can be include or encompass Dedicated Short Range Communication (DSRC)/Wireless Access in Vehicular Environment (WAVE) with radio communication provided by IEEE 802.11p and cellular networks with 3G or 4G support. A vehicle 110V periodically sends beacons to its neighbors, which contains data as identification, timestamp, position, speed (direction), acceleration, among other 7700 signals, approximately, collected by sensors of the vehicle. A beacon contains sensitive information, which may be used in many applications of interest to the industry, companies or government. One widely used application is traffic management.

Analyzing the voluminous data and information generated and collected in an ITS can bring enormous social benefits, but it also brings concerns about data breaches and leakage. The main challenge for entities performing statistical analyses on sensitive data is to release aggregated information about a population while protecting the privacy of its individuals. Disclosure of this data poses a serious threat to the privacy of individual contributors, which creates a liability for industry and governments.

Differential privacy has become increasingly accepted as a privacy technique of choice. Differential privacy technology can help to discover the usage patterns of a large number of users without compromising individual privacy. To obscure an individual's identity, differential privacy adds mathematical noise to a small sample of the individual's usage pattern. In the context of analyses over a database (statistics or machine learning), it is a strong mathematical definition of privacy. Its definition allows the possibility of a useful analysis be performed on a data set while protecting the privacy of contributors in this data set.

According to some embodiments, systems and methods are provided for an instance-based data aggregation solution for traffic management that satisfies the differential privacy definition. In some examples, a simple or basic approach to compute the average speed is evaluated and then an enhanced solution with an instance-based technique is provided to mitigate the negative impact on accuracy. In some embodiments, the systems and methods of the present disclosure use a sample-and-aggregate framework to construct a new instance that has low sensitivity for the median function. This disclosure provides a detailed evaluation of privacy-preserving techniques based on differential privacy applied to traffic monitoring. The systems and methods of the present disclosure have been validated through simulations in typical traffic congestion scenarios. The results show that for typical instances (e.g., under-dispersed), the systems and methods provide a significant reduction in the number of outliers, considering a deviation tolerance from the original reported average speed.

### Differential Privacy

Differential privacy emerged from the problem of performing statistical studies on a population while attempting to maintain the privacy of its individuals. The definition of differential privacy models the risk of disclosing data from any individual belonging to a database by performing statistical analyses on it. The definition says that, using a randomized algorithm in two databases differing by only one element, the probabilities of producing the same result are bounded by a constant factor. For example, imagine that there are two otherwise identical databases, but one has your information in it, and the other does not. Differential privacy ensures that the probability that a statistical query will produce a given result is (nearly) the same whether the query is conducted on the first or second database. In other words, a differentially private algorithm will behave similarly to similar input databases.

Definition 1. Differential privacy. A randomized algorithm A taking inputs from the domain Dⁿ gives (ϵ; δ)-differential privacy analysis if for all data sets D₁, D₂∈Dⁿ differing on at most one element, and all U⊆Range(A), denoting the set of all possible outputs of A,

$$\vert ln \{ \frac{Pr [ A ( {D}_{1} ) ∈ U ] - δ}{Pr [ A ( {D}_{2} ) ∈ U ]} \} \vert \leq ϵ \qquad ( 1 )$$

where the probability space is over the coin flips of the mechanism A and

$$\frac{P}{0}$$

is defined as 1 for all p∈ [symbol] .

Two fundamental parameters control the level of privacy in a differentially private algorithm. The privacy loss parameter, denoted by ϵ, is the main parameter. This parameter E can be thought of as the magnitude of the constant factor that determines the indistinguishability between two databases differing in one element. In other words, parameter ϵ is a relative measure of privacy breach risk. It quantifies the contribution of each individual on the output of the analysis and controls the trade-off between privacy and utility. The second parameter is the relaxation parameter, denoted by δ. This parameter allows negligible leakage of information from individuals in an analysis performed on a database. In other words, an (ϵ, δ)-differential privacy algorithm requires that an (ϵ, 0)-differential privacy algorithm be satisfied with a probability of at least 1−δ; that is, the (ϵ, 0)-differential privacy algorithm can be violated for some tuples and the probability of that occurring it is linearly bounded by δ.

The protection of the individuals' privacy in a database is made by masking the contribution (presence or absence) of any single individual in the analysis, making it infeasible to infer any information specific to an individual. In this way, it is sufficient to mask an upper bound of the attribute of interest in the related database. This upper bound is known as global sensitivity. In other words, global sensitivity is related to an analysis function; it is the maximum difference between the analyses performed over two databases differing only in one element:

Definition 2. Global sensitivity. For ƒ: Dⁿ→ [symbol] ^{d} the global sensitivity Δ off is

$${Δ}_{f} = {max}_{{D}_{1} , {D}_{2} ∈ {D}^{n} \cdot d ( {D}_{1} , {D}_{2} ) = 1} {‖ f ( {D}_{1} ) - f ( {D}_{2} ) ‖}_{1} \qquad ( 2 )$$

where Dⁿ is the domain of all databases of size n and d(D₁, D₂)=1 means that for all D₁, D₂ the difference between these database is bounded by one element.

A differentially private analysis protects the privacy of an individual by adding carefully-tuned random noise when producing statistics. One of the main models of computation, in which a differentially private algorithm works, is the centralized model. In the centralized model, also known as output perturbation, there is a trusted party that has access to individuals' data without perturbation and uses it to release noisy aggregate analyses.

In order to add carefully-tuned random noise to the computation, two of the main primitives satisfying differential privacy are the Laplace and exponential mechanisms. The Laplace mechanism is the first and probably most widely used mechanism. This mechanism is based on sampling continuous random variables from a Laplace distribution. This distribution presents the following probability density function:

$$h ( x , μ , b ) = \frac{1}{2 b} e \text{?} , \\ \text{?} \text{indicates text missing or illegible when filed} \qquad ( 3 )$$

where b>0 is the scale parameter and μ is the location parameter. In order to get an independent and identically distributed random variable from a Laplace distribution, its probability density function must be calibrated by centering the location parameter at zero and setting the scale parameter as the ratio between the global sensitivity (Δ_{ƒ}) and the privacy loss parameter (ϵ). In the centralized model of computation, the Laplace mechanism works by computing the value of the aggregate function ƒ over a database D, sampling a random variable Y from Laplace distribution and adding it to the computation. That is, M(D)=ƒ(D)+Y, where Y˜h(x, 0, Δ_{ƒ}/ϵ).

On the other hand, the exponential mechanism is used to handle both numerical and categorical analysis. The exponential mechanism may work well for situations in which it is desirable to output the best response among finite (countable) options, an arbitrary range, but adding noise directly to the output of the analysis can compromise the output quality of the same. Due the finite set of output options, the exponential mechanism for categorical analysis is discrete, and defined as follows.

Definition 3. Exponential mechanism. For any quality function, q: (Dⁿ×O)→ [symbol] and a privacy parameter ϵ, the exponential mechanism outputs an element o∈O with probability

$$∝ e ( \frac{∈ q ( D , 0 )}{2 {Δ}_{q}} ) ,$$

where O is a set of all possible outputs and

$${Δ}_{q} = {max}_{∀ o ∈ O} {‖ q ( {D}_{1} , o ) - q ( {D}_{2} , o ) ‖}_{1} \qquad ( 4 )$$

is the sensitivity of the quality function with D₁, D₂∈Dⁿ; d(D₁, D₂)=1.

It has been observed that the Laplace mechanism can be viewed as a special case of the exponential mechanism, by using the quality function as q(D, o)=−|ƒ(D)−o|, which provides Δ_{q}=Δ_{ƒ}. In fact, the Laplace distribution is known as double exponential distribution, because it can be thought of as two exponential distributions with an additional location parameter splicing both distributions [20]. In this way, considering the case of numerical analysis, it is sufficient to assume q(D, o)=−|ƒ(D)−o| for exponential mechanism, whereas the output o can be viewed as zero, which gives the true value of the analysis.

Definition 4. Monotonic function. A function ƒ performed over a database is monotonic if the addition of an element to the database cannot cause the value of the function to decrease. That is, ƒ(D₁)≥ƒ(D₂) if d (D₁, D₂)=1 and |D₁|≥|D₂|, and vice-versa.

It has been proven that if a quality function is monotonic then the exponential mechanism can output o∈O with probability

$$∝ e ( \frac{∈ q ( D , o )}{{Δ}_{q}} ) .$$

The exponential distribution presents the following probability density function:

h(x,λ)=λe^{-λx}, (5)

where λ>0 is the rate parameter.

Composability The composition theorems are useful to understand how to combine multiple mechanisms for designing differentially private algorithms. The privacy loss parameter ϵ will degrade along repeatedly analyses over databases containing the same elements. As such, it is often referred to as the privacy budget, since it needs to be divided and consumed by a sequence of differentially private algorithms to attend a sequence of analyses. There are two main composition theorems, the sequential and parallel compositions.

Theorem 1. Sequential composition. Let A₁(D), . . . , Aₖ(D) be k algorithms that satisfy (ϵ₁, δ₁), . . . , (ϵₖ, δₖ)-differential privacy, respectively. Then, an algorithm A, such as A (D)=A[A₁(D), . . . , Aₖ(D)] is (Σᵢ₌₁^{k}ϵᵢ, Σᵢ₌₁^{k}δᵢ) differentially private.

Theorem 2. Parallel composition. Given a deterministic partitioning ƒ, such as D₁, . . . , Dₖ are resulting partitions of ƒ over D. Let A₁(D), . . . , Aₖ(D) be k algorithms that satisfy (ϵ₁, δ₁), (ϵₖ, δₖ)-differential privacy, respectively. Then, A(D)=A [A₁(D), . . . , Aₖ(D)] is (maxᵢ₌₁^{k}ϵᵢ, maxᵢ₌₁^{k}δᵢ)-differentially private.

### Instance-Based Additive Noise

In one embodiment of a differential privacy framework, the noise magnitude depends on the global sensitivity (Δ_{ƒ}, Definition 2), but not on the instance D. For many functions, such as the median, this framework yields high noise, compromising the utility of the analysis. Two frameworks have been proposed that allow noisy analyses to be performed with magnitude proportional to the instance in question. These frameworks are known as smooth sensitivity, and sample and aggregate.

Local Sensitivity. Local sensitivity is a local measure of sensitivity. It depends directly from the instance in question. Local sensitivity allows or enables adding significantly less noise as compared to calibrating with global sensitivity. In some embodiments, local sensitivity is defined as follows.

Definition 5. Local sensitivity. For ƒ: Dⁿ→ [symbol] ^{d} and D₁∈Dⁿ, the local sensitivity of ƒ at D₁ is

$${LS}_{f} ( {D}_{1} ) = {max}_{y : d ( {D}_{1} , {D}_{2} ) = 1} {‖ f ( {D}_{1} ) - f ( {D}_{2} ) ‖}_{1} . \qquad ( 6 )$$

However, this scheme does not satisfy differential privacy, since it can change abruptly when the instance changes, revealing information about the instance.

Smooth Sensitivity. The idea behind the smooth sensitivity framework is to find the smallest upper bound on the local sensitivity such that adding noise proportional to this upper bound is safe. This upper bound is known as smooth sensitivity. It is a measure of variability of a function ƒ performed over all neighborhood of the instance in question:

Definition 6. Smooth sensitivity. For β>0, the β-smooth sensitivity off is:

$${S}_{f , β}^{*} ( {D}_{1} ) = {max}_{h = 0 , … , n} {e}^{- k , β} ( {max}_{{D}_{2} : d ( {D}_{1} , {D}_{2} ) = k} {LS}_{f} ( {D}_{2} ) ) . \qquad ( 7 )$$

One can add noise proportional to

$$\frac{{S}_{f , β}^{*} ( x )}{α} ,$$

where α, β are parameters of the noise distribution.

Let a database D={d₁, . . . , dₙ} in a non-decreasing order and ƒ_{med}=median(D) where dᵢ∈ [symbol] , with dᵢ=0 for i≤0 and dᵢ=Δ_{ƒ} for i>n. It has been proven that the β-smooth sensitivity of Median function is

$${S}_{f , β}^{*} ( D ) = {max}_{k = 0 , … , n} [ {e}^{- k , β} {max}_{t = 0 , … , k + 1} ( {d}_{m + i} - {d}_{m + i - k \vert - 1} ) ] , \qquad ( 8 )$$

where m is the rank of median element and

$$m = \frac{n + 1}{2}$$

for odd n. It can be computed in time O(n²).

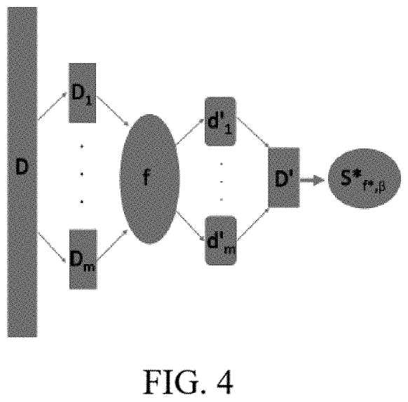

Sample and Aggregate Framework. FIG. 4 illustrates the procedure of the sample and aggregate framework 400 or technique, according to some embodiments. The intuition behind this framework 400 is to replace an aggregate function ƒ by a smoothed and efficient version of it. Let D={d₁, . . . , dₙ} be an n size database, then sample and aggregate works as follows. (i) Firstly, a new database D′ derived from the original database D should be created. For this, D is divided into m small databases {D₁, . . . , Dₘ} through random partitions of size n/m, which is sub-linear in n. Then, D′={dᵢ′, . . . , dₘ′} is created by evaluating ƒ on these partitions. (ii) After that, a new aggregate function ƒ* with low sensitivity is chosen, and ƒ*(D′) is published through smooth sensitivity framework.

The intuition behind the technique is that changing a single point in D will change very few small databases dᵢ′∈D′, and hence very few evaluations ƒ*(D′). The output ƒ*(D′) will be close to ƒ(D) if ƒ can be approximated well on random partitions. This evaluation is quantified by the following definition.

Definition 7. Good approximation. A function ƒ: Dⁿ→R is well approximated from random partitions {D₁, . . . , Dₘ} of a database D if

Pr{d_{M}[|ƒ(Dᵢ),ƒ(D)]≤r}≥¾, (9)

where d_{M} is some metric, r is a ratio of accuracy and i∈{1, . . . , m}.

### Privacy Level

The level of privacy is with respect to the degree of protection of an individual or entity by differentially private mechanisms. In other words, what should be protected from an entity, the entity itself, or an action of the same? Two levels of privacy have been described—event protection and user protection.

Event-level Privacy. In event-level privacy, privacy protection is centered on an event, i.e., it protects the privacy of individual accesses. Thus, data set is an unbounded stream of events. An event may be an interaction between a particular person and an arbitrary term. If the data set is dynamic, i.e., the attribute changes for each interaction; an event is unique and its ID (identification) is the combination of timestamp, user ID and attribute value. Otherwise, the data set is static and an event must occur once for the same particular person. In this latter case, if the occurrence of an interaction for the same particular person happens more than once, events will be cumulative, and user-level privacy will be dealt with by composition theorems.

User-level Privacy. Privacy protection in user-level privacy is centered on a user. That is, user-level privacy protects the presence or absence of an individual in a stream, independent of the number of times it arises, should it actually be present at all. At any time interval on the stream, several interactions between a particular person and an arbitrary term should arise. In this case, privacy loss parameter E should be monitored and bounded. This implies an upper bound on the privacy loss of a particular person due to the participation on the statistical study. In order to ensure that differential privacy is satisfied, the progress of privacy budget should be checked over a period of time.

### Basic Approach for Calculating Average Speed

This section describes a simple or basic approach, e.g., to calculate average speed, in a differentially private way through a prefix of a finite length formed from an unbounded data stream containing beacons reported by vehicles crossing a road segment. A simple solution was initially presented by Kargl et al., “Differential privacy in intelligent transportation systems,” In: WiSec '13 Proceedings of the sixth ACM Conference on Security and Privacy in Wireless and Mobile Networks, pp. 107-112, ACM, Budapest, Hungary (2013), the entirety of which is incorporated by reference herein, that considered the original framework of differential privacy.

According to some embodiments, an enhanced or improved solution focuses instead on event-level privacy, following the problem statement, and adds noise proportional to global sensitivity in a centralized model through the Laplacian distribution. In the version according to some embodiments of the present disclosure, the size of prefix is calculated in a differentially private way by using the exponential mechanism, since negative values are not of interest.

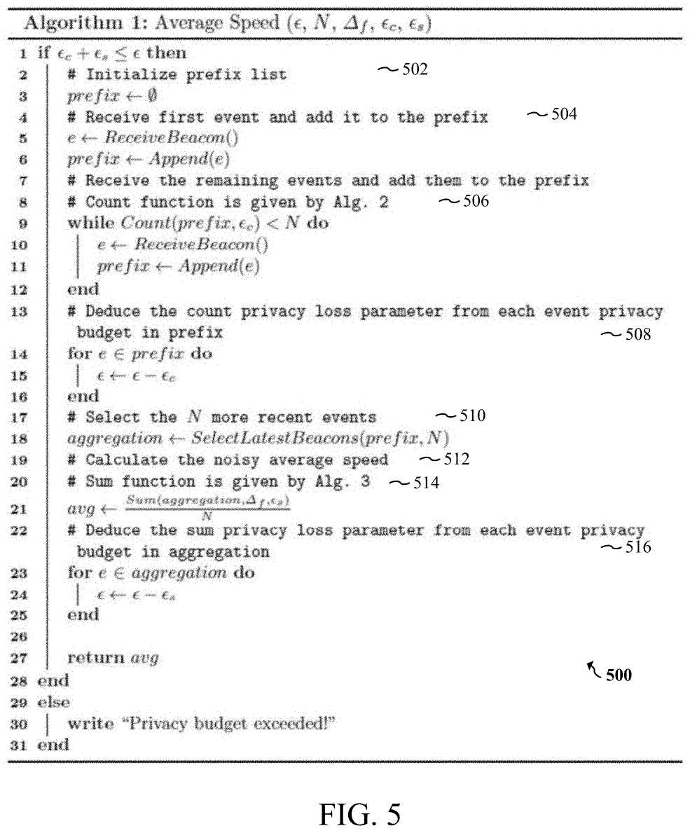

FIG. 5 illustrates a method 500 (Algorithm 1) for calculating the average speed in a differentially private way, according to some embodiments. In some examples, method 500 may be performed or implemented, in whole or in part, by one or more devices, objects, users, equipment, or entities 110 or 150 operating in the example V2X environment or ITS architecture, as described above with reference to FIGS. 1-3B. These may include, but are not limited to, vehicles, on-board equipment or unit (OBE or OBU), roadside equipment or unit (RSE or RSU), and computer systems or networks, incorporated therein or located separately (e.g., in the cloud), for generating, collecting, storing, and processing data. In some embodiments, method 500 uses all beacons reported (e.g., by RSU) in a short time interval in a specific road segment. The method 500 receives as input a privacy budget E related to each event received in the RSU, the aggregation size N to calculate the average speed, the global sensitivity of Sum function (maximum allowed speed value in the road segment), and the privacy loss parameters ϵ_{c} and ϵₛ for Count and Sum functions.

Firstly, the method 500 starts with an empty set called prefix used to store beacons received by RSU. At a process 502, the RSU initializes the prefix list.

Next, at a process 504, the RSU starts collecting or receiving data (for events e), adding (or appending) each of them to the prefix. This continues with the RSU receiving and appending data for the remaining events.

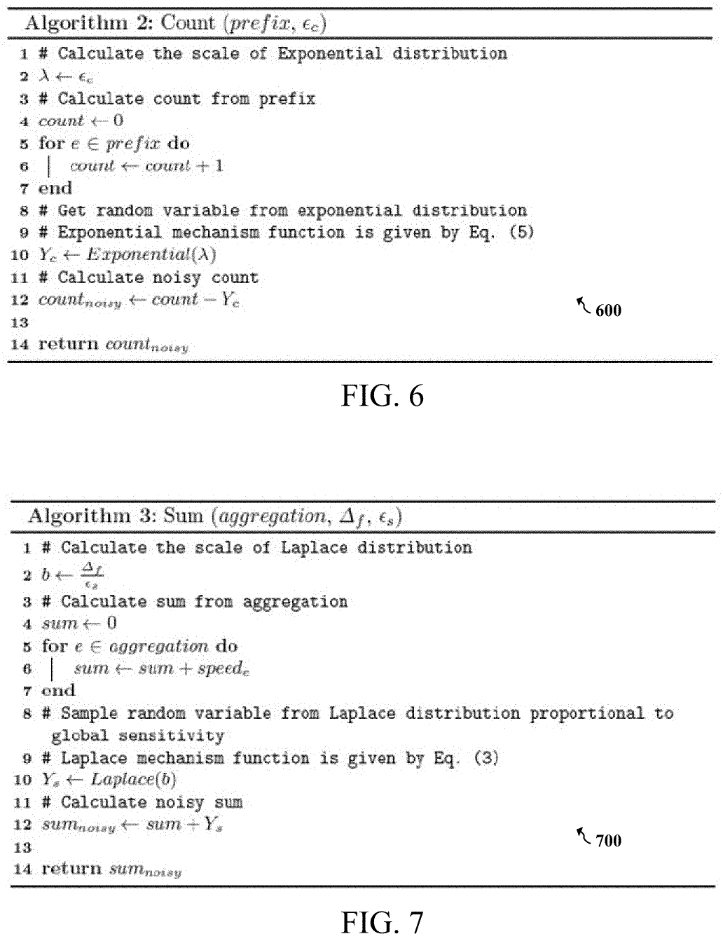

The control of collection is made by a differentially private Count function, at a process 506, which uses the exponential mechanism. The Count function, in some examples, is given by or performed according to a method 600 (Algorithm 2), as shown in FIG. 6. The event collection is performed by the Receive Beacon function. Each beacon includes the speed (m/s) of a vehicle between 0 and M, where M is the maximum allowed speed in a specific road segment, i.e. M is the global sensitivity Δ_{ƒ}. In a realistic scenario, some values can be above M, but these values are not protected proportional to their magnitude, since in our scenario these are reckless drivers.

At a process 508, the privacy loss parameter ϵ_{c} of the Count function is then deduced from the privacy budget E of each event.

After collecting enough data to compose an aggregation, at a process 510, method 500 selects the most recent beacons to calculate the average speed. In some examples, the average speed is calculated as follows: i) at a process 512, calculate the noisy sum from N latest reported speeds through the Laplace mechanism; then, ii) at a process 514, compute the average speed of the road segment as the ratio between the noisy sum and the size of the aggregation. The Sum function, in some examples, is given by or performed according to a method 700 (Algorithm 3), as shown in FIG. 7.

Finally, at a process 516, the privacy loss parameter ϵₛ of the Sum function is deduced from the privacy budget E for each event in the aggregation.

A security analysis of the methods 500, 600, 700 (Algorithms 1, 2 and 3) for the basic or simple approach is provided below.

### Enhanced Approach for Calculating Average Speed

This section describes an enhanced approach, e.g., to compute or calculate average speed on a road segment, that meets the differential privacy definition while providing accurate aggregate information. This approach was inspired by the observation that most speed values are close to the average when measured in a short time interval and road segment, but there exist anomalies (few values outside of this range). Thus, an idea of the hypothesis is that cropping a range in the original prefix can eliminate anomalies and produce accurate analysis, since it allow us to introduce less but significant noise to protect the maximum element in that instance. However, the noise magnitude might reveal information about the prefix. That is, the choice of range itself is sensitive data leaking information about events in the prefix and, as such, should be chosen under a differentially private algorithm.

In some embodiments, the enhanced solution is based on the sample-and-aggregate framework. Details of such framework are provided in Nissim et al., “Smooth sensitivity and sampling in private data analysis,” In: Proceedings of the Thirty-ninth Annual ACM Symposium on Theory of Computing, pp. 75184, (2007), the entirety of which is incorporated by reference herein. This sample-and-aggregate framework considers the instance-based additive noise problem and allow or enables adding significantly less noise in typical instances, where most speed values are close to the average, while maintaining privacy requirements.

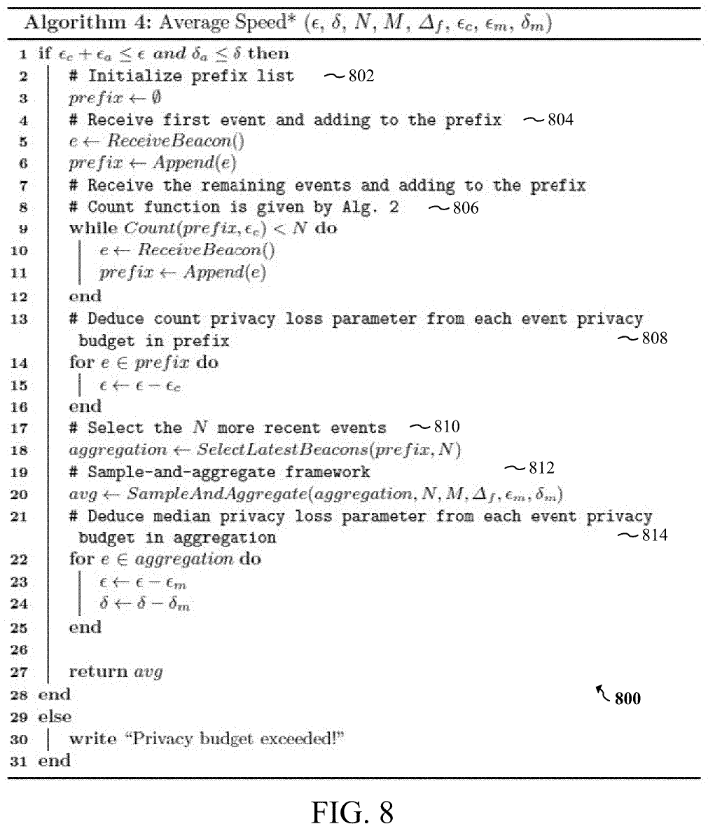

The approach proposed herein is presented in FIG. 8, which illustrates a method 800 (Algorithm 4) for calculating the average speed in a differentially private way, according to some embodiments. In some examples, method 800 may be performed or implemented, in whole or in part, by one or more devices, objects, users, equipment, or entities 110 or 150 operating in the example V2X environment or ITS architecture, as described above with reference to FIGS. 1-3B. These may include, but are not limited to, vehicles, on-board equipment or unit (OBE or OBU), roadside equipment or unit (RSE or RSU), and computer systems or networks, incorporated therein or located separately (e.g., in the cloud), for generating, collecting, storing, and processing data. Method 800 is focused on event-level privacy and adds noise proportional to smooth sensitivity of the median function through a Laplacian distribution.

In some embodiments, method 800 (Algorithm 4) is similar to method 500 (Algorithm 1). One difference between method 500 and method 800, respectively the basic and enhanced approaches, is that while in the basic approach we add noise proportional to global sensitivity of the Sum function, in the enhanced approach we add noise proportional to smooth sensitivity of the Median function.

The method 800 receives as input a privacy budget E related to each event received in the RSU, the aggregation size N to calculate the average speed, the global sensitivity of Sum function (maximum allowed speed value in the road segment), and the privacy loss parameters ϵ_{c} and ϵₛ for Count and Sum functions. Method 800 receives as additional inputs the relaxation budget parameter δ differing from zero, the number of partitions M over the aggregation list, and the privacy and relaxation parameters ϵₘ and δₘ for the Median function. The global sensitivity of the Median function is the same as the Sum function (maximum allowed speed value in the road segment).

Method 800 starts with an empty set called prefix used to store beacons received by RSU. At a process 802, the RSU initializes the prefix list.

Next, at a process 804, the RSU starts collecting or receiving data (for events e), adding (or appending) each of them to the prefix. This continues with the RSU receiving and appending data for the remaining events.

The control of collection is made by a differentially private Count function, at a process 806, which uses the exponential mechanism. The Count function, in some examples, is given by or performed according to a method 600 (Algorithm 2), as shown in FIG. 6. The event collection is performed by the Receive Beacon function. Each beacon includes the speed (m/s) of a vehicle between 0 and M, where M is the maximum allowed speed in a specific road segment, i.e. M is the global sensitivity Δ_{ƒ}.

At a process 808, the privacy loss parameter ϵ_{c} of the Count function is then deduced from the privacy budget ϵ of each event.

After receiving all beacons from vehicles crossing the road segment and adding them to the prefix list, the aggregation set is composed through selection of most recent events. At a process 810, method 800 selects the most recent beacons to calculate the average speed.

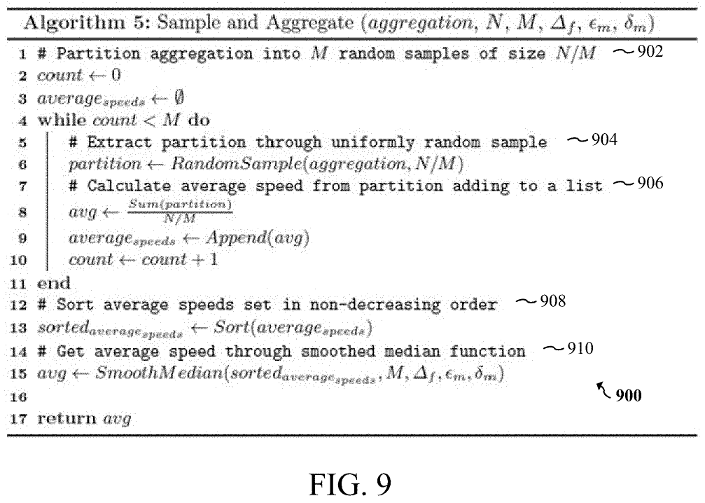

At a process 812, method 800 calculates the average speed using the sample and aggregate framework or approach. In some examples, the sample and aggregate framework is given by or performed according to a method 900 (Algorithm 5), as shown in FIG. 9.

Referring to FIG. 9, method 900 starts at a process 902 by partitioning an aggregation set into M partitions.

In some examples, at a process 904 each partition is composed (or extracted) by uniformly distributed samples of size N=M without replacement. For each partition, at a process 906 the average speed is calculated and the result is stored in a set called average speeds.

Once this set is filled with M average speeds, at a process 908, the average speeds set is sorted, e.g., in non-decreasing order.

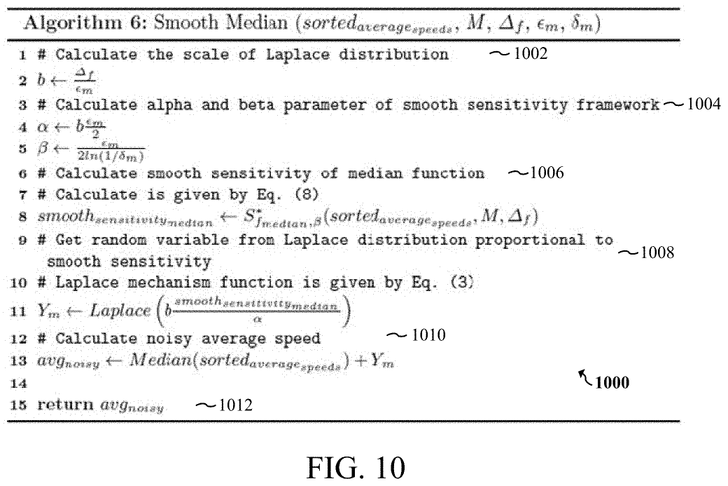

At a process 910, the smooth sensitivity of the median function is calculated over the average speeds set as an instance. In some examples, the Smooth Median function is given by or performed according to a method 1000 (Algorithm 6), as shown in FIG. 10.

Referring to FIG. 10, the Smooth Median function receives as input the average speeds set, its size M, the global sensitivity Δ_{ƒ} of Median function, and the privacy and relaxation parameters ϵₘ and δₘ for Median function. At a process 1002, method 1000 calculates the scale of Laplace distribution, and at a process 1004, calculates alpha a and beta β parameters of the smooth sensitivity framework. In method 1000, at a process 1006 the smooth sensitivity of Median function is calculated getting as instance the sorted average speeds set. This calculation is given by Eq. (8). From it, at a process 1008, a random variable is extracted from a Laplace distribution proportional smooth sensitivity of Median function over sorted average speeds set. At a process 1010, the noisy average speed is calculated as the median of sorted average speeds set added to the extracted random variable. At a process 1012, method 1000 (Algorithm 6) returns the noisy average speed.

Returning again to FIG. 8, finally, in method 800, at a process 814, the privacy loss parameter ϵₘ of the Median function is deduced from the privacy budget value ϵ of each event in the aggregation.

A security analysis of the methods 800, 900, and 1000 (Algorithms 4, 5 and 6) for the enhanced approach is provided below.

### Hybrid Approach for Calculating Average Speed

In this section, we describe a hybrid approach to calculate the average speed on a road segment satisfying the definition of differential privacy. This approach combines the original differential privacy framework (ODP) to the sample and aggregate framework (SAA). The adoption of the latter was inspired by the hypothesis that most speed values are close to the average when measured in a short time interval and road segment yielding some well-behaved instances. The hybrid approach is justified by the dynamism of the application, which yields misbehaved instances leading to very high sensitivity in the SAA framework.

The noise magnitude from the original and smooth sensitivity techniques are not related. While the differences among the instance and its neighbors are taken into account to get the noise magnitude in the smooth sensitivity, the original technique considers only the global sensitivity without examining the instance itself. The core of our contribution is to propose a formulation relating these techniques in order to obtain the lowest noise magnitude, which results in more accurate analyses.

From now on, we will refer to the collected set of beacons as a prefix, a finite length chain from an unbounded stream of beacons. In the hybrid approach, we calculate the noisy prefix size by using the exponential mechanism. To calculate the average speed, we use the Laplace mechanism in both ODP and SAA frameworks.

One way to calculate the differentially private average function using the ODP framework is to add a random variable, sampled from the Laplace distribution, to the true sum function, then, divide it by the set size N to obtain the average. In this case, the scale parameter is set as

$$\frac{{Δ}_{f}}{∈} .$$

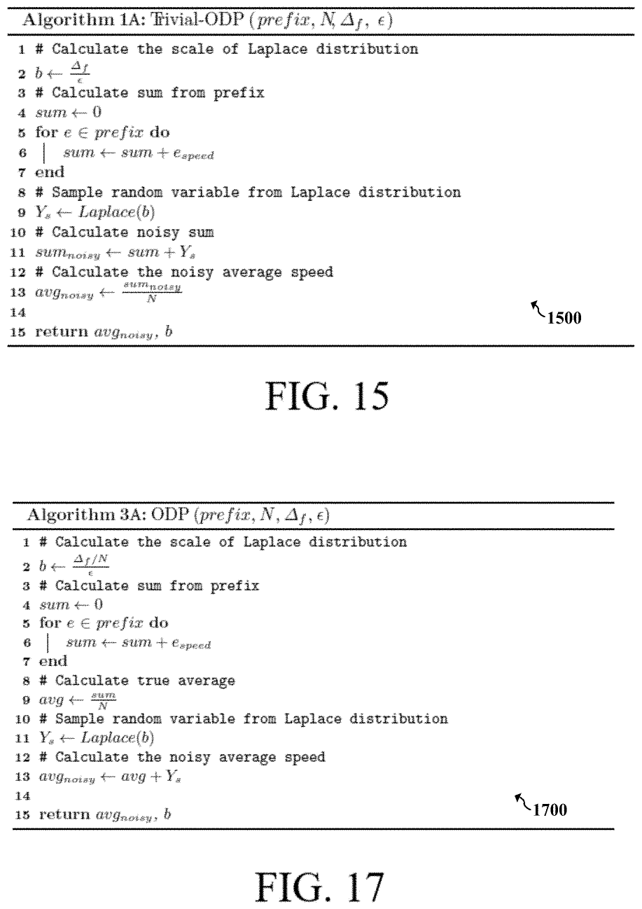

The method 1500 (Algorithm 1A) of FIG. 15 illustrates this procedure.

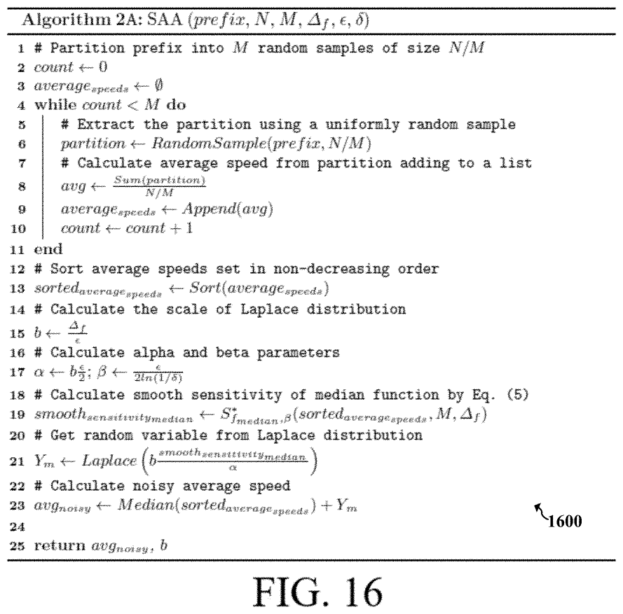

On the other hand, using the SAA framework, we can divide the prefix into random partitions and evaluate the average function over each partition. After this process, we sort the resulting data set where we will select the central element (median) as the average speed. One idea is to reduce the impact of anomalies present in the prefix when calculating the aggregation. It allow us to introduce less but significant noise to protect the maximum element in well-behaved instances. FIG. 16 illustrates a method 1600 (Algorithm 2A) for this Sample and Aggregate Function, according to some embodiments.

The Hybrid approach is based in the following lemma and theorem.

Lemma 2A. Let a prefix P={x₁, x₂, . . . xₙ₋₁, xₙ} be a set of points over [symbol] , such that xᵢ∈[0, Δ_{ƒ}] for all i. Sampling a random variable from the Laplace distribution with scale parameter set as

$$\frac{{Δ}_{f} / N}{∈}$$

and add it to the true average function is equivalent to Algorithm 1 both performed over P.

Proof. Consider the cumulative distribution function of the Laplace distribution with mean (μ=0). Suppose S is the sum of P and rₛ=λ·S represents a proportion of S. The probability of sampling any value greater than rₛ is given by

$${p}_{s} ( X > {r}_{s} ) = \frac{1}{2} {e}^{- \frac{{r}_{a}}{{s}_{a}}} \\ where \\ {b}_{s} = \frac{{Δ}_{f}}{ϵ} . \qquad ( 6 A )$$

Now, suppose A is the average of P and rₐ=λ·A represents a proportion of A. The probability of sampling any value greater than rₐ is given by

$${p}_{a} ( X > {r}_{a} ) = \frac{1}{2} {e}^{- \frac{{r}_{a}}{{s}_{a}}} \qquad ( 7 A )$$

In order to conclude the proof, we need to determine bₐ. So, it is a fact that S=A·N. Thus, we have rₛ=λ·A·N, which results in rₛ=rₐ·N. By substituting it in Eq. (6A) and equaling to Eq. (7A), i.e., pₛ=pₐ, we obtain

$${b}_{a} = \frac{{Δ}_{f} / N}{ϵ} .$$

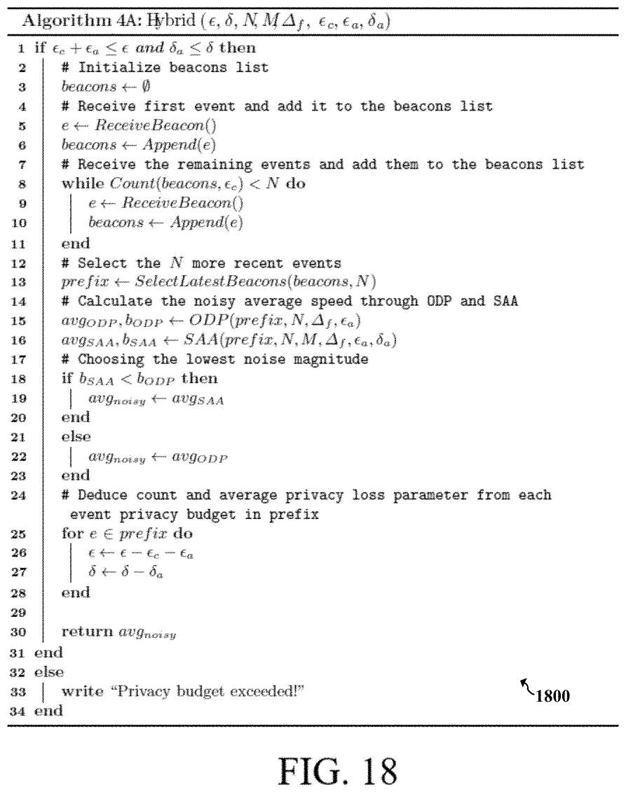

Based on Lemma 2, the following construction (Algorithm 3A), as shown in the method 1700 of FIG. 17, is an alternative to Original Differential Privacy framework, according to some embodiments.

Theorem 1A. Let a prefix P={x₁, x₂, . . . xₙ₋₁, xₙ} be a set of points over [symbol] , such that xᵢ∈[0, Δ_{ƒ}] for all i. Then, the method 1600 (Algorithm 2A) of FIG. 16 provide more accurate results than the method 1700 (Algorithm 3A) of FIG. 17, if

$${S}_{{f}_{median ,} , β}^{*} ( D ) < ∝ \cdot \frac{{Δ}_{f} / N}{ϵ} ,$$

both performed over P.

Proof. Let b_{SAA} and b_{ODP} be the scale parameter of the Laplace distribution in the methods 1600 (Algorithm 2A) and 1700 (Algorithm 3A), respectively. Then, we obtain

$$\begin{matrix}{b}_{SAA} = \frac{{S}_{{f}_{median ,} , β}^{*} ( D )}{α} & ( 8 A ) \\ {b}_{ODP} = \frac{{Δ}_{f} / N}{ϵ} & ( 9 A )\end{matrix}$$

Rearranging Eq. (8) and setting b_{ODP} as an upper bound on b_{SAA}, we get if S_{ƒ}_{_{median}}_{,β}*(D)<∝·b_{ODP}, which results in

$${S}_{{f}_{median ,} , β}^{*} ( D ) < ∝ \cdot \frac{{Δ}_{f} / N}{ϵ} \qquad ( 10 A )$$

In order to prove this theorem, assume for the sake of contradiction that Algorithm 3 provide more accurate results than method 1600 (Algorithm 2A), both performed over P. Then, b_{ODP} is less than b_{SAA}. By Eq. (10A), it is a contradiction.

Therefore, if Eq. (10A) is the premise, method 1600 (Algorithm 2A) provides more accurate results than method 1700 (Algorithm 3A).

From Theorem 1 and Lemma 2, the noise magnitude of the Hybrid approach is formulated as follows:

$${b}_{{H}_{ybrid}} = \{ \begin{matrix}{b}_{SAA} , if {S}_{{f}_{median ,} , β}^{*} ( D ) < ∝ \cdot \frac{{Δ}_{f} / N}{ϵ} \\ {b}_{ODP} , otherwise .\end{matrix} \qquad ( 11 A )$$

FIG. 18 illustrates a method 1800 (Algorithm 4) for calculating average speed in a differentially private way according to the Hybrid approach, in some embodiments. This method 1800 calculates the average speed in a differentially private way using all beacons reported in a short time interval in a specific road segment. Method 1800 receives as input a privacy budget ϵ related to each received event in the base station, the prefix size N to calculate the average speed, the number of partitions for SAA framework, the global sensitivity of the average function Δ_{ƒ} (speed limit in the road segment), the privacy loss parameters ϵ_{c} and ϵₐ for count and average functions, and the relaxation parameter δₐ for average function (non-zero).

The method 1800 starts by checking the privacy budget of the privacy loss and relaxation parameters. After that, it initializes an empty list called beacons used to store all beacons received through the base station. Next, the base station starts collecting data (beacons/events) adding each of them to the list. The collection control is made by a differentially private Count function which uses the exponential mechanism, method 1600 (Algorithm 2A, FIG. 6). The event collection is performed by the Receive Beacon function. Each beacon includes the vehicle speed (m/s) between 0 and Δ_{ƒ}. It is worth mentioning that, in a realistic scenario, some values can be above the speed limit Δ_{ƒ} but these values are intentionally not protected in proportion to their magnitude, since in our scenario they are reckless drivers. After collecting enough data to compose the prefix, the method 1800 selects the most recent beacons to calculate the average speed. The next step is calculate the noisy average speed through the two frameworks, ODP and SAA. Then, we choose the average noisy speed calculated with the lowest noise magnitude. Finally, the privacy loss and relaxation parameters is deduced from the privacy budget for each event in the prefix.

### Analysis and Results

This section presents and discusses the results obtained from evaluation of the basic and enhanced approaches for average speed calculation. Since the evaluation focuses on accuracy of the proposed solutions, the two fundamental parameters—privacy loss parameter ϵ and relaxation parameter δ—were fixed and calibrated. For this evaluation, we set the privacy loss parameter E considering each aggregation function with the following values: ln(2)−0:15 for Sum function, 0:15 for Count function and ln(2)−0:15 for Median function. Since the aggregation set size for this evaluation has been defined as the value of 55, it is sufficient calibrate the relaxation parameter δ with 0:01, which is a negligible value over the size of the aggregation set.

In order to evaluate the approaches, the analysis adopts the open source traffic mobility (SUMO) and the discrete event-based (OMNeT++) simulators. In addition, the open source framework for running vehicular network simulations (Veins) is used as an interface of the two simulators. The evaluation is made on two simple synthetic scenarios which try to simulate real traffic jam situations.

We adopt the absolute deviation as a utility metric, and built a filter with a deviation tolerance (margin of error) of 10% in the original reported average speed a caused by the introduction of noise. In other words, we desire that the reported noisy average speed n, Eq. (10), should stay within a confidence interval with a confidence level of 95%, and any reported measurement outside of this range is considered an outlier.

n=a±(0.1*a) (10)

As result, we calculate the number of outliers obtained in a simulation time window and present the behavior of the real average speed as well as the approximation of the two solutions or approaches (basic and enhanced). In addition, we show the quality of original and derived instances by presenting two standardized measures of dispersion besides the approximation of random partitions, given by definition 7. We use the relative deviation as a metric chosen to evaluate the random partitions in this definition with ratio of accuracy r fixed in 0:01, thus meeting the requirements of our utility metric. These mentioned numerical and graphical results for both approaches are presented below, organized by scenarios.

### First Scenario

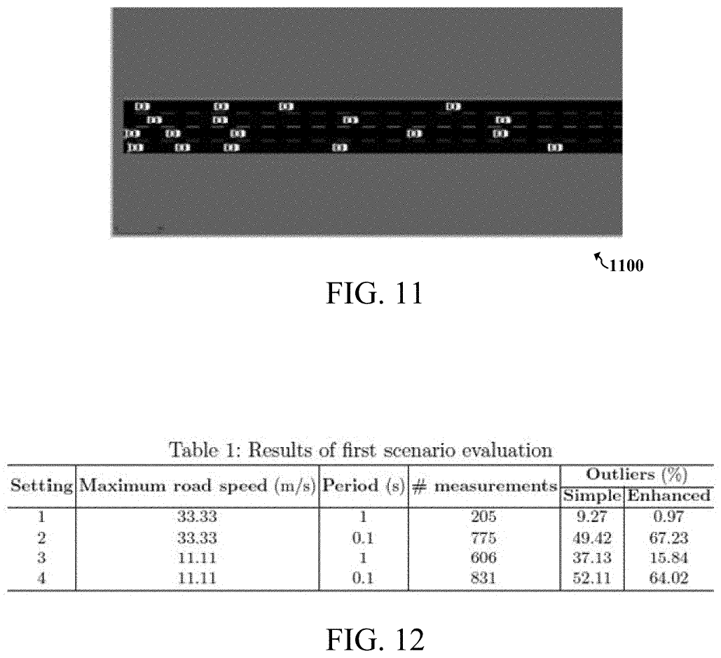

The first evaluation is made in a synthetic scenario 1100 containing simple SUMO features. As shown in FIG. 11, scenario 1100 has 2500 cars crossing a 500-meter road segment with four lanes, and a fixed RSU in the center of the road segment with a communication radius of 150 meters. The maximum speed on this road segment is 33:33 m/s, used as global sensitivity Δ_{ƒ}. The parameters at SUMO are varied in order to get four traffic conditions and each simulation is completed after all cars have crossed the road segment.

In the first traffic condition, we consider that all cars are traveling at the maximum speed of the road segment, with a car insertion time period of 1 second, so that there is no congestion, considered an ideal condition. The second traffic condition differs from the first by car insertion frequency of 0:1 second, forcing a traffic jam. In this setting, cars would automatically reduce their speeds to avoid collisions.

We retake the car insertion frequency of 1 second in the third setting, and force all cars to travel at a maximum speed of 11:11 m/s, even though the maximum road speed is 33:33 m/s. In the fourth and last setting, we only modify the car insertion time period to 0:1 second, related to third setting.

Summarized results for the first scenario appear in Table 1, shown in FIG. 12. Table 1 presents the setting parameters mentioned before, as well as the number of measurements and outliers for simple and enhanced approaches taken in the simulation time window.

The numerical results in Table 1 show that the basic or simple approach works well in ideal scenarios (Setting 1), where all or most of cars are traveling at or close to the maximum road speed (global sensitivity), getting an average speed close to the global sensitivity. When the speed of vehicles move away from the maximum road speed, caused by congestion (Settings 2, 3 or 4), the basic approach get more outliers due to the distance between the average and maximum road speed.

On the other hand, the enhanced approach presents good results in Settings 1 and 3, but its performance may be negatively affected in Settings 2 and 4. The amount of noise added to the smooth median depends on the Euclidean distance between an element and the values of its neighbors in the instance, then, the enhanced approach presents good results when we obtain well behaved instances (Settings 1 and 3), that is, instances with low variance. Instances with high variance yield average speed calculations distant from most elements in the instance.

In Setting 2, the number of outliers increases drastically, while the basic approach presents about 49% of outliers, and the enhanced approach presents about 67%. This jump is due to the amount of vehicles inserted in the scenario in a short period of time, causing a congestion.

Settings 3 and 4 have the same behavior in their results. Forcing vehicles to travel at maximum speed of 11:11 m/s degrade too much the accuracy of the basic approach.

The enhanced approach presents good results for Setting 3, where we get only 15:84% of outliers. This result is due to good behavior of the original instances that are under-dispersed in Setting 3, getting most values below to 0:5. In Setting 4, the number of outliers is about 64%. This result is due to the misbehavior of original instances, caused by the car insertion time period of 0:1 second. The original instances in Setting 4 are classified as over-dispersed, presenting index of dispersion between 1:5 and 2.

### Second Scenario

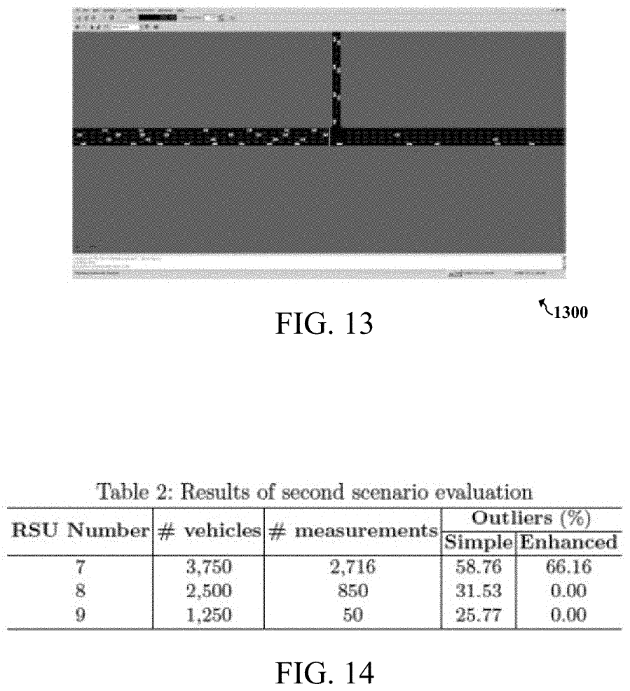

The second scenario 1300 is slightly more complex than the first. As shown in FIG. 13, in scenario 1300, the size of the main road is increased to 2000-meter and a 500-meter exit road with two lanes is included. The scenario has 3750 vehicles, of which 1250 follow the exit. Three RSUs, each with a communication radius of 150 meters, are fixed at the centers of the three road segments. The maximum road speed of 33:33 m/s has been maintained from first scenario for each road segment.

In this scenario, during the simulation time window, we evaluate the average speed measurements from each RSU, which are related to each road segment. RSU 7 is attached to the first road segment, before the exit road. RSU 8 is fixed after the exit road. RSU 9 is attached to the exit road. We consider that all cars can travel at the maximum speed of the road segments, and the insertion time period of vehicles is set to 1 second.

Numerical results appear in Table 2 shown in FIG. 14, where we can see that the enhanced approach gets better results than the basic or simple approach in two of three segment roads. This is due to traffic jam on the first road segment caused by vehicles taking the exit road.

In RSU 7, the simple or basic approach gets almost 60% of outliers. The enhanced approach reaches about 66%, a high value, over simple approach.

RSUs 8 and 9 have the same behavior, both with average speed values practically constant, about 13:77 m/s. The simple approach performance degrades with this behavior, presenting more than 30% of outliers in RSU 8 and about 26% in RSU 9. On the other hand, the enhanced approach enjoys this behavior, presenting no outliers in both RSU's, as shown in Table 2 (FIG. 13). This is due to the good behavior of the original instances, that are under-dispersed with most values below 10⁻⁴. It induces getting very little sensitivity values.

### Security Analysis

### Basic Approach for Calculating Average Speed

The security of the simple or basic approach is supported by the following Lemmas 1 and 2, and Theorem 3. In Lemma 1, we prove that the randomized Count function presented in Algorithm 2 (FIG. 6) is differentially private. After that, Lemma 2 shows that randomized Sum function presented in Algorithm 3 (FIG. 7) satisfies differential privacy. Finally, in Theorem 3, we prove that simple or basic approach presented in Algorithm 1 (FIG. 5) satisfies differential privacy by sequential composition.

Lemma 1. Let a prefix P=(x₁, x₂, . . . xₙ₋₁, xₙ} be a set of points over [symbol] such that xᵢ∈[0, Δ_{ƒ}] for all i and |P| be the length of the prefix. Then, Algorithm 2 satisfies (ϵ_{c}, 0)-differential privacy.

Proof. Assume that, without loss of generality, A represents Algorithm 2. Let P₁ and P₂ be two neighbouring prefixes differing by at most one event. From Eq. (1) in the differential privacy definition, we have to evaluate two cases: when the ratio is greater than 1 and less equal to 1. Since the quality of the Count function is monotonic:

$$\begin{matrix} - When \frac{Pr [ A ( {P}_{1} ) ∈ U ]}{Pr [ A ( {P}_{2} ) ∈ U ]} \geq 1 , we have \\ \begin{matrix} \frac{Pr [ A ( {P}_{1} ) ∈ U ]}{Pr [ A ( {P}_{2} ) ∈ U ]} = \frac{{\int }_{U} {ϵ}_{o} \text{?} dx}{{\int }_{U} {ϵ}_{o} {e}^{- {ϵ}_{o} ( x + 1 )} dx} \\ = \frac{{ϵ}_{o} {\int }_{a}^{b} {e}^{- {ϵ}_{o} x} dx}{{ϵ}_{o} {\int }_{a}^{b} {e}^{- {ϵ}_{o} ( x + 1 )} dx} \\ = \text{?} \geq {e}^{- {ϵ}_{o} .}\end{matrix} & ( 11 ) \\ - When \frac{Pr [ A ( {P}_{1} ) ∈ U ]}{Pr [ A ( {P}_{2} ) ∈ U ]} < 1 , we have by symmetry that \\ \frac{Pr [ A ( {P}_{1} ) ∈ U ]}{Pr [ A ( {P}_{2} ) ∈ U ]} \geq {e}^{- {ϵ}_{o}} . \\ \text{?} \text{indicates text missing or illegible when filed} & ( 12 )\end{matrix}$$

Lemma 2. Let S be an aggregation set of points from a prefix P=(x₁, x₂, . . . xₙ} over [symbol] such that xᵢ∈[0, Δ_{ƒ}] for all i. Then, Algorithm 3 (FIG. 70 satisfies (ϵₛ, 0)-differential privacy.

Proof. Assume now, without loss of generality, A represents Algorithm 3. Let S₁ and S₂ be two neighboring aggregations differing by at most one event. From the definition of differential privacy:

$$- When \frac{Pr [ A ( {S}_{1} ) ∈ U ]}{Pr [ A ( {S}_{2} ) ∈ U ]} \geq 1 , we have \\ \begin{matrix}\frac{Pr [ A ( {S}_{1} ) ∈ U ]}{Pr [ A ( {S}_{2} ) ∈ U ]} = \frac{{\int }_{U} \frac{{ϵ}_{s}}{2 {Δ}_{f}} {e}^{- \frac{{ϵ}_{s} \vert x \vert}{{Δ}_{f}}} dx}{{\int }_{U} \frac{{ϵ}_{s}}{2 {Δ}_{f}} {e}^{- \frac{{ϵ}_{s} \vert x + {Δ}_{f} \vert}{{Δ}_{t}}} dx} \\ = \frac{\frac{{ϵ}_{s}}{2 {Δ}_{f}} {\int }_{a}^{b} {e}^{- \frac{{ϵ}_{s} \vert x \vert}{{Δ}_{f}}} dx}{\frac{{ϵ}_{s}}{2 {Δ}_{f}} {\int }_{a}^{b} {e}^{- \frac{{ϵ}_{s} \vert x + {Δ}_{f} \vert}{{Δ}_{f}}} dx} \\ = \frac{{\int }_{a}^{b} {e}^{- \frac{{ϵ}_{s} \vert x \vert}{{Δ}_{j}}} dx}{{\int }_{a}^{b} {e}^{- \frac{{ϵ}_{s} \vert x + {Δ}_{f} \vert}{{Δ}_{f}}} dx}\end{matrix} \qquad \text{(13)}$$

We will solve this ratio in two parts. First, considering numerator of Eq. (13), we have to evaluate two cases, when x≥0 and x<0.
Considering the case when x≥0, we have

$${\int }_{a}^{b} {e}^{- \frac{{ϵ}_{s} x}{{Δ}_{f}}} dx = \frac{{Δ}_{f} [ {e}^{- ( {ϵ}_{s} a ) / {Δ}_{f}} - {e}^{- ( {ϵ}_{s} b ) / {Δ}_{f}} ]}{{ϵ}_{s}} . \qquad ( 14 )$$

When x<0, we have

$${\int }_{a}^{b} {e}^{\frac{{ϵ}_{s} x}{{Δ}_{f}}} dx = - \frac{{Δ}_{f} [ {e}^{( {ϵ}_{s} a ) / {Δ}_{f}} - {e}^{( {ϵ}_{s} b ) / {Δ}_{f}} ]}{{ϵ}_{s}} . \qquad ( 15 )$$

Now, considering denominator of Eq. (13), we have to evaluate the cases when x≥−Δ_{ƒ} and x<−Δ_{ƒ}.
When x≥−Δ_{ƒ}, we have

$${\int }_{a}^{b} {e}^{- \frac{{ϵ}_{s} ( x + {Δ }_{f} )}{{Δ}_{f}}} dx = \frac{{e}^{- {ϵ}_{s}} {Δ}_{f} [ {e}^{- ( {ϵ}_{s} a ) / {Δ}_{f}} - {e}^{- ( {ϵ}_{s} b ) / {Δ}_{f}} ]}{{ϵ}_{s}} . \qquad ( 16 )$$

Now, when x<−Δ_{ƒ}, we obtain

$${\int }_{a}^{b} {e}^{\frac{{ϵ}_{s} ( x - {Δ }_{f} )}{{Δ}_{f}}} dx = - \frac{{e}^{- {ϵ}_{s}} {Δ}_{f} [ {e}^{( {ϵ}_{s} a ) / {Δ}_{f}} - {e}^{( {ϵ}_{s} b ) / {Δ}_{f}} ]}{{ϵ}_{s}} . \qquad ( 17 )$$

By replacing Eq. (14) and Eq. (16) in Eq. (13), we obtain

$$\frac{\frac{{Δ}_{f} [ {e}^{- ( {ϵ}_{s} a ) / {Δ}_{f}} - {e}^{- ( {ϵ}_{s} b ) / {Δ}_{f}} ]}{{ϵ}_{s}}}{\frac{{e}^{- {ϵ}_{s}} {Δ}_{f} [ {e}^{- ( {ϵ}_{s} a ) / {Δ}_{f}} - {e}^{- ( {ϵ}_{s} b ) / {Δ}_{f}} ]}{{ϵ}_{s}}} \leq {e}^{{ϵ}_{s}} \qquad ( 18 )$$

Similarly, by substituting Eq. (15) and Eq. (17) in Eq. (13), we have

$$\begin{matrix} - When \frac{Pr [ C ( {P}_{1} ) ∈ T ]}{Pr [ C ( {P}_{2} ) ∈ T ]} \geq 1 , we have \\ \begin{matrix}\frac{Pr [ C ( {P}_{1} ) ∈ T ]}{Pr [ C ( {P}_{2} ) ∈ T ]} = \frac{Pr [ A ( {P}_{1} ) ∈ U ] Pr [ B ( {P}_{1} ) ∈ V ]}{Pr [ A ( {P}_{2} ) ∈ U ] Pr [ B ( {P}_{2} ) ∈ V ]} \\ = \{ \frac{Pr [ A ( {P}_{1} ) ∈ U ]}{Pr [ A ( {P}_{2} ) ∈ U ]} \} \{ \frac{Pr [ B ( {P}_{1} ) ∈ V ]}{Pr [ B ( {P}_{2} ) ∈ V ]} \} \\ - [ \frac{{\int }_{U} \frac{{ϵ}_{c}}{{Δ}_{f}} {e}^{- \frac{{ϵ}_{c} x}{{Δ}_{f}}} dx}{{\int }_{U} \frac{{ϵ}_{c}}{{Δ}_{f}} {e}^{- \frac{{ϵ}_{c} ( x + {Δ}_{f} )}{{Δ}_{f}}} dx} ] [ \frac{{\int }_{V} \frac{{ϵ}_{s}}{2 {Δ}_{f}} {e}^{- \frac{{ϵ}_{s} \vert x \vert}{{Δ}_{f}}} dx}{{\int }_{V} \frac{{ϵ}_{s}}{2 {Δ}_{f}} {e}^{- \frac{{ϵ}_{s} \vert x + {Δ}_{f} \vert}{{Δ}_{f}}} dx} ] \leq {e}^{{ϵ}_{c} + {ϵ}_{s}} .\end{matrix} & ( 21 ) \\ - When \frac{Pr [ C ( {P}_{1} ) ∈ T ]}{Pr [ C ( {P}_{2} ) ∈ T ]} < 1 , we have by symmetry that \frac{Pr [ C ( {P}_{1} ) ∈ T ]}{Pr [ C ( {P}_{2} ) ∈ T ]} \geq {e}^{- ( {ϵ}_{c} + {ϵ}_{s} )} . & ( 22 )\end{matrix}$$

Theorem 3. Let a prefix P=(x₁, x₂, . . . xₙ₋₁, xₙ} be a set of points over [symbol] such that xᵢ∈[0, Δ_{ƒ}] for all i. Then, Algorithm 1 (FIG. 5) satisfies (ϵ, 0)-differential privacy.

Proof. From Lemma 1 and 2 we have that Algorithms 2 and 3 are differentially private. We now show that their combination preserves (ϵ_{c}+ϵₛ, 0)-differential privacy.

Assume, without loss of generality, that A, B and C are random algorithms representing Algorithm 2, 3 and their combination, respectively. Let P₁ and P₂ be two neighboring prefixes differing by at most one event. From the definition of differential privacy:

$$\begin{matrix} When \frac{Pr [ C ( {P}_{1} ) ∈ T ]}{Pr [ C ( {P}_{2} ) ∈ T ]} \geq 1 , we have \begin{matrix}\frac{Pr [ C ( {P}_{1} ) ∈ T ]}{Pr [ C ( {P}_{2} ) ∈ T ]} = \frac{Pr [ A ( {P}_{1} ) ∈ U ] Pr [ B ( {P}_{1} ) ∈ V ]}{Pr [ A ( {P}_{2} ) ∈ U ] Pr [ B ( {P}_{2} ) ∈ V ]} \\ = \{ \frac{Pr [ A ( {P}_{1} ) ∈ U ]}{Pr [ A ( {P}_{2} ) ∈ U ]} \} \{ \frac{Pr [ B ( {P}_{1} ) ∈ V ]}{Pr [ B ( {P}_{2} ) ∈ V ]} \} \\ = [ \frac{{\int }_{U} \frac{{ϵ}_{c}}{{Δ}_{f}} {e}^{- \frac{{ϵ}_{c} v}{{Δ}_{f}}} dx}{{\int }_{U} \frac{{ϵ}_{c}}{{Δ}_{f}} {e}^{- \frac{{ϵ}_{c} ( x + {Δ}_{f} )}{{Δ}_{f}}} dx} ] [ \frac{{\int }_{V} \frac{{ϵ}_{s}}{2 {Δ}_{f}} {e}^{- \frac{{ϵ}_{s} \vert x \vert}{{Δ}_{f}}} dx}{{\int }_{V} \frac{{ϵ}_{s}}{2 {Δ}_{f}} {e}^{- \frac{{ϵ}_{s} \vert x + {Δ}_{f} \vert}{{Δ}_{f}}} dx} ] \leq {e}^{{ϵ}_{c} + {ϵ}_{s}} .\end{matrix} & ( 21 ) \\ When \frac{Pr [ C ( {P}_{1} ) ∈ T ]}{Pr [ C ( {P}_{2} ) ∈ T ]} < 1 , we have by symmetry that \frac{Pr [ C ( {P}_{1} ) ∈ T ]}{Pr [ C ( {P}_{2} ) ∈ T ]} \geq {e}^{- ( {ϵ}_{c} + {ϵ}_{s} )} . & ( 22 )\end{matrix}$$

From Algorithm 1, we have combination of Algorithm 2 and 3 when ϵ_{c}+ϵₛ≤ϵ. Therefore, in this case, we have that Algorithm 1 satisfies (ϵ, 0)-differential privacy.

### Enhanced Approach for Calculating Average Speed

To demonstrate the security of the enhanced approach, we show that Smooth Median function, presented in Algorithm 6 (FIG. 10), is differentially private by Lemma 4. For this, before, we will prove, by Definition 8, that the Laplace distribution can be used to add noise proportional to the smooth sensitivity of Median function. After that, through sequential composition (Theorem 1), we will prove that Algorithm 4 (FIG. 8) satisfies differential privacy definition in Theorem 5.

Definition 8. Admissible Noise Distribution. A probability distribution h∈ [symbol] is (α, β)-admissible for α(ϵₘ, δₘ) and β(ϵₘ, δₘ) if it satisfies the following inequalities:

$$\begin{matrix}\vert ln [ \frac{{Pr}_{X ∼ h} ( X ∈ U ) - \frac{{δ}_{m}}{2}}{{Pr}_{X ∼ h} ( X ∈ U + Δ )} ] \vert \leq {ϵ}_{m} / 2 & ( 23 ) \\ \vert ln [ \frac{{Pr}_{X ∼ h} ( X ∈ U ) - \frac{{δ}_{m}}{2}}{{Pr}_{X ∼ h} ( X ∈ U \cdot {e}^{λ} )} ] \vert \leq {ϵ}_{m} / 2 & ( 24 )\end{matrix}$$

for all ∥Δ∥≤α|λ|≤β and all subsets U⊆ [symbol] .

This definition states that a probability distribution that does not change too much under translation and dilation can be used to add noise proportional to S_{ƒ,β}*.

Lemma 3. The Laplace distribution on [symbol] , Eq. (3) (FIG. 7), is (α, β)-admissible with

$$α = b \frac{{ϵ}_{m}}{2} and β = \frac{{ϵ}_{m}}{2 ln ( 1 / {δ}_{m} )} .$$

Proof. From Definition 8, we can obtain α and β parameters. Since Laplace distribution are not a heavy tail distribution, then δₘ>0.

Considering Eq. 23, we have

$$When \frac{{Pr}_{X ∼ h} ( X ∈ U ) - \frac{{δ}_{m}}{2}}{{Pr}_{X ∼ h} ( X ∈ U + Δ )} \geq 1 , we have \begin{matrix}\frac{{Pr}_{X ∼ h} ( X ∈ U ) - \frac{{δ}_{m}}{2}}{{Pr}_{X ∼ h} ( X ∈ U + Δ )} = \frac{{\int }_{U} \frac{1}{2 b} {e}^{- \frac{\vert x \vert}{b}} dx - \frac{{δ}_{m}}{2}}{{\int }_{U + Δ} \frac{1}{2 b} {e}^{- \frac{\vert x \vert}{b}} dx} \\ = \frac{\frac{1}{2 b} {\int }_{c}^{d} {e}^{- \frac{\vert x \vert}{b}} dx - \frac{{δ}_{m}}{2}}{\frac{1}{2 b} {\int }_{c}^{d} {e}^{- \frac{\vert x + Δ \vert}{b}} dx} = \frac{{\int }_{c}^{d} {e}^{- \frac{\vert x \vert}{b}} dx - \frac{{δ}_{m}}{2}}{{\int }_{c}^{d} {e}^{- \frac{\vert x + Δ \vert}{b}} dx}\end{matrix} \qquad ( 25 )$$

Considering numerator of Eq. (25), we have to evaluate interval [c, d] in two cases,

$$\begin{matrix}when x \geq 0 : {\int }_{c}^{d} {e}^{- \frac{x}{b}} dx = b ( {e}^{- c / b} - {e}^{- d / b} ) , & ( 26 ) \\ and when x < 0 : {\int }_{c}^{d} {e}^{\frac{x}{b}} dx = - b ( {e}^{c / b} - {e}^{d / b} ) . & ( 27 )\end{matrix}$$

Now, considering denominator of Eq. (25), we have

$$\begin{matrix}when x \geq - Δ : {\int }_{c}^{d} {e}^{- \frac{a + Δ}{b}} dx = {e}^{- Δ / b} b ( {e}^{- c / b} - {e}^{- d / b} ) , & ( 28 ) \\ and when x < - Δ : {\int }_{c}^{d} {e}^{\frac{x - Δ}{b}} dx = - {e}^{- Δ / b} b ( {e}^{c / b} - {e}^{d / b} ) . & ( 29 )\end{matrix}$$

By substituting Eq. (26) and Eq. (28) in Eq. (25) we obtain

$$\frac{b ( {e}^{- c / b} - {e}^{- d / b} ) - \frac{{δ}_{m}}{2}}{{e}^{- Δ / b} b ( {e}^{- c / b} - {e}^{- d / b} )} = {e}^{Δ / b} \frac{b ( {e}^{- c / b} - {e}^{- d / b} ) - \frac{{δ}_{m}}{2}}{b ( {e}^{- c / b} - {e}^{- d / b} )} \leq {e}^{{ϵ}_{m} / 2} ⇔ {e}^{Δ / b} \leq {e}^{{ϵ}_{m} / 2} \frac{b ( {e}^{- c / b} - {e}^{- d / b} )}{b ( {e}^{- c / b} - {e}^{- d / b} ) - \frac{{δ}_{m}}{2}} . \qquad ( 30 )$$

When δₘ tends to zero in Eq. (30), the ratio tends to 1. Thus, assuming a very small δₘ (negligible), we get

$$Δ \leq b ( {ϵ}_{m} / 2 ) + ln [ \frac{b ( {e}^{- c / b} - {e}^{- d / b} )}{b ( {e}^{- c / b} - {e}^{- d / b} ) - \frac{{δ}_{m}}{2}} ] \approx b ( {ϵ}_{m} / 2 ) . \qquad ( 31 )$$

Similarly, by replacing Eq. (27) and Eq. (29) in Eq. (25) we get the same result, Δ≤b (ϵₘ/2).

$$When \frac{{Pr}_{X ∼ h} ( X ∈ U ) - \frac{{δ}_{m}}{2}}{{Pr}_{X ∼ h} ( X ∈ U + Δ )} < 1 , we have by symmetry that \\ \frac{{Pr}_{X ∼ h} ( X ∈ U ) - \frac{{δ}_{m}}{2}}{{Pr}_{X ∼ h} ( X ∈ U + Δ )} \geq {e}^{- {ϵ}_{m} / 2} \approx {e}^{- Δ / b} \geq {e}^{- {ϵ}_{m} / 2} \approx Δ \leq b ( {ϵ}_{m} / 2 ) . \qquad ( 32 )$$

Therefore, it is sufficient to admit α=b (ϵₘ/2), so that the translation property is satisfied with probability

$$1 - \frac{{δ}_{m}}{2} .$$

Considering Eq. (24), we have

$$When \frac{{Pr}_{X ∼ h} ( X ∈ U ) - \frac{{δ}_{m}}{2}}{{Pr}_{X ∼ h} ( X ∈ U \cdot {e}^{λ} )} \geq 1 , we have \\ \begin{matrix}\frac{{Pr}_{X ∼ h} ( X ∈ U ) - \frac{{δ}_{m}}{2}}{{Pr}_{X ∼ h} ( X ∈ U \cdot {e}^{λ} )} = \frac{{\int }_{U} \frac{1}{2 b} {e}^{- \frac{\vert x \vert}{b}} dx - \frac{{δ}_{m}}{2}}{{\int }_{U \cdot {e}^{λ}} \frac{1}{2 b} {e}^{- \frac{\vert x \vert}{b}} dx} \\ = \frac{{\int }_{c}^{d} {e}^{- \frac{\vert x \vert}{b}} dx - \frac{{δ}_{m}}{2}}{{\int }_{c}^{d} {e}^{- \frac{\vert {ϵ}^{λ} x \vert}{b}} dx}\end{matrix} \qquad ( 33 )$$

Numerator of Eq. (33) is given by Eq. (26) and (27). On the other hand, denominator of Eq. (33) is given by evaluate interval [c, d] in two cases,

$$\begin{matrix}when x \geq 0 : {\int }_{c}^{d} {e}^{- \frac{{ϵ}^{λ} x}{b}} dx = {e}^{- λ} b [ {e}^{- {e}^{λ} c ) / b} - {e}^{- ( {e}^{λ} d / b} ] , & ( 34 ) \\ and when x < 0 : {\int }_{c}^{d} {e}^{\frac{{e}^{λ} x}{b}} dx = - {e}^{- λ} b [ {e}^{( {e}^{λ} c ) / b} - {e}^{( {e}^{λ} d ) / b} ] . & ( 35 )\end{matrix}$$

By replacing Eq. (26) and Eq. (34) in Eq. (33) we obtain

$$\frac{b ( {e}^{- c / b} - {e}^{- d / b} ) - \frac{{δ}_{m}}{2}}{{e}^{- λ} b [ {e}^{- ( {e}^{λ} c ) / b} - {e}^{- ( {e}^{λ} d ) / b} ]} \leq {e}^{{ϵ}_{m} / 2} {e}^{λ} \leq {e}^{{ϵ}_{m} / 2} \frac{b [ {e}^{- ( {ϵ}^{λ} c ) / b} - {e}^{- ( {e}^{λ} d ) / b} ]}{b ( {e}^{- c / b} - {ϵ}^{- d / b} ) - \frac{{δ}_{m}}{2}} \qquad ( 36 )$$

From an analysis of Eq. (36), we can conclude that, regardless of values of b, c and d, where d>c, the ratio tends to zero when we get high values of λ. This is because the value of δₘ is negligible. When we get λ tending to zero, the ratio tends to 1. Thus, an acceptable upper bound for λ, so that Eq. (36) is satisfied with high probability, is ϵₘ/(2 ln(1/δₘ)). This value tends to zero when we get a very small value for δₘ.

Similarly, by replacing Eq. (27) and Eq. (35) in Eq. (33) we obtain the same result, λ≤ϵₘ/(2 ln(1/δₘ)).

$$When \frac{{Pr}_{X ∼ h} ( X ∈ U ) - \frac{{δ}_{m}}{2}}{{Pr}_{X ∼ h} ( X ∈ U \cdot {e}^{λ} )} < 1 , we have by symmetry that \\ \frac{{Pr}_{X ∼ h} ( X ∈ U ) - \frac{{δ}_{m}}{2}}{{Pr}_{X ∼ h} ( X ∈ U \cdot {e}^{λ} )} \geq {e}^{- {ϵ}_{m} / 2} , \\ which results in - λ \geq - {ϵ}_{m} / ( 2 ln ( 1 / {δ}_{m} ) ) . \qquad ( 37 )$$

Therefore, to satisfy dilation property with probability

$$1 - \frac{{δ}_{m}}{2} ,$$

it is enough to assume β=ϵₘ/(2 ln(1/δₘ)).

Lemma 4. Let Y be a random variable sampled from a Laplace distribution. Then, Algorithm 6 is ϵₘ differentially private with probability 1−δₘ.

Proof. The proof follows by combination of Definition 8 and Lemma 3.

Theorem 4. Let S be an aggregation set of points from a P=(x₁, x₂, . . . xₙ} over [symbol] such that xᵢ∈[0, Δ_{ƒ}] for all i. Then, Algorithm 5 satisfies (ϵₘ, δₘ)-differential privacy and yields accurate aggregation result.

Proof. Our construction is based on uniformly distributed samples from the aggregation set. These random samples are extracted without replacement, producing partitions of size N=M on the aggregation set. From it, an M size set is constructed by calculating the average speed over these partitions. Finally, to calculate the smooth sensitivity of Median function from Eq. (8), it is needed to sort the aggregate set in a non-decreasing order. Thus, Algorithm 5 (FIG. 9) follows the sample and aggregate framework.

If a function ƒ can be approximated well over random partitions of a database, then, a differentially private version of ƒ can be released with a significantly little noise. The accuracy of this approximation can be measured following Definition 7. In fact, in this case, changing a single element in the aggregation set does not affect significantly the result of Algorithm 5, since most values in aggregation set will be close to the average.

Therefore, the proof of this theorem follows by a combination of Lemma 4, Theorem 2 and Definition 7.

Theorem 5. Let prefix P=(x₁, x₂, . . . xₙ₋₁, xₙ} be a set of points over [symbol] such that xᵢϵ[0, Δ_{ƒ}] for all i. Then, Algorithm 4 satisfies (ϵ, δ)-differential privacy.

Proof. From Lemma 1 and Theorem 4 we have that Algorithms 2 and 5 satisfy (ϵ_{c}, 0) and (ϵₘ, δₘ)-differential privacy. Thus, by Theorem 1, we have that Algorithm 4 satisfies (ϵ_{c}+ϵₘ, δₘ)-differential privacy. Therefore, as in Algorithm 4 the combination of Algorithm 2 and 5 occurs when ϵ_{c}+ϵₘ≤ϵ and δₘ≤δ, then, Algorithm 4 is (ϵ, δ)-differentially private.

According to some embodiments, an instance-based data aggregation solution is disclosed herein for traffic monitoring based on differential privacy, focusing on event-level privacy. In some embodiments, an enhanced approach for differentially private solution (e.g., for average speed calculation) uses, employs, or is implemented with the smooth sensitivity and sample and aggregate framework. Experimental results have shown that the enhanced approach is superior to a basic or simple approach for differential privacy in situations which present at least a little jam with under-dispersed instances, following the hypothesis that vehicles will traveling in the same speed in a short period of time and space.

The embodiments described above illustrate but do not limit the invention. For example, the techniques described for vehicles can be used by other mobile systems, e.g., pedestrians' smartphones or other mobile systems equipped with computer and communication systems 150. The term “vehicle” is not limited to terrestrial vehicles, but includes aircraft, boats, space ships, and maybe other types of mobile objects. The vehicle techniques can be also be used by non-mobile systems, e.g., they can be used on a computer system.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures typically represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

1. A method for providing differential privacy in traffic monitoring, the method comprising:
setting a privacy budget applicable to each of one or more traffic events;
receiving information for the one or more traffic events;
appending the information for the one or more traffic events to a prefix;
wherein the receiving and appending of information for the one or more traffic events to the prefix is controlled according to a count function;
deducing a privacy loss parameter of the count function from the privacy budget of each event in the prefix;
calculating an average for a metric relating to the traffic events using a sample and aggregate framework; and
deducing a privacy loss parameter of a median function from the privacy budget of each event in aggregation.

2. The method of claim 1, wherein the count function comprises calculating a count from the prefix list.

3. The method of claim 2, wherein the count function comprises obtaining a random variable from an exponential distribution.

4. The method of claim 3, wherein the count function comprises determining a noisy count by deducing the random variable from the count.

5. The method of claim 1, wherein the sample and aggregate framework comprises partitioning an aggregation set into partitions.

6. The method of claim 5, wherein the partitioning is random.

7. The method of claim 1, wherein the sample and aggregate framework comprises obtaining the average for a metric relating to the traffic events according to a smooth median function.

8. The method of claim 7, wherein metric relating to the traffic events is speed of a vehicle.

9. The method of claim 8, comprising sorting by average speed.

10. The method of claim 1, wherein the sample and aggregate framework comprises replacing an aggregate function with a smoothed version of the aggregate function.

11. A system for providing differential privacy in traffic monitoring, the system comprising:
one or more processors and computer memory at a first entity, wherein the computer memory stores program instructions that when run on the one or more processors cause the first entity to:
set a privacy budget applicable to each of one or more traffic events;
receive information for the one or more traffic events;
append the information for the one or more traffic events to a prefix;
wherein the receiving and appending of information for the one or more traffic events to the prefix is controlled according to a count function;
deduce a privacy loss parameter of the count function from the privacy budget of each event in the prefix;
calculate an average for a metric relating to the traffic events using a sample and aggregate framework; and
deduce a privacy loss parameter of a median function from the privacy budget of each event in aggregation.

12. The system of claim 11, wherein the count function comprises calculating a count from the prefix list.

13. The system of claim 12, wherein the count function comprises obtaining a random variable from an exponential distribution.

14. The system of claim 13, wherein the count function comprises determining a noisy count by deducing the random variable from the count.

15. The system of claim 11, wherein the sample and aggregate framework comprises partitioning an aggregation set into partitions.

16. The system of claim 15, wherein the partitioning is random.

17. The system of claim 11, wherein the sample and aggregate framework comprises obtaining the average for a metric relating to the traffic events according to a smooth median function.

18. The system of claim 17, wherein metric relating to the traffic events is speed of a vehicle.

19. The system of claim 18, comprising sorting by average speed.

20. The system of claim 11, wherein the sample and aggregate framework comprises replacing an aggregate function with a smoothed version of the aggregate function.

21. The system of claim 11, wherein the first entity comprises a traffic data center.
